(19) United States
(12) Patent Application Publication
(10) Pub. No.: US 2011/0047483 A1
(43) Pub. Date: Feb. 24, 2011

(54) MESSAGING SYSTEM

(76) Inventors: Sydney G. Low, Kew (AU); Matthew I. Walker, Heidelberg Heights (AU)

Correspondence Address: WOLF GREENFIELD & SACKS, P.C., 600 ATLANTIC AVENUE, BOSTON, MA, 02210-2206, US

(21) Appl. No.: 12/864,251

(22) PCT Filed: Jan. 23, 2009
(86) PCT No.: PCT/AU09/00075

§ 371 Date: Oct. 5, 2010

(30) Foreign Application Priority Data
Jan. 24, 2008 (AU) 2008900322

(51) Int. Cl. G06F 15/16; G06F 3/01; H04W 4/00

(52) U.S. Cl. 715/752; 709/206; 455/466

(57) ABSTRACT

A messaging system for a wireless communications network, including: a creation component for creating a message; a sending component for transmitting the message as a message service message for a recipient, and for adding to said message instructions for the recipient for providing an acknowledgement; an acknowledgement component for processing response data to determine whether said response data represents said acknowledgement for said message; a database for maintaining status data for said message, said status data being set by one or more of the components; and an interface component for use in displaying a status of said message based on said status data.

### FIELD

The present invention relates to a messaging system for a wireless communications network.

### BACKGROUND

Wireless communications networks, such as satellite communications networks and mobile cellular telecommunications networks, are used to send messages to personal communication devices, such as pagers and mobile telephones. Paging networks, which rely on a number of different paging protocols, send messages over the network to a recipient associated with a pager, and are used to contact personnel, such as doctors, in the case of an emergency. Most pagers, however, are only able to receive messages, and cannot transmit any form of acknowledgement. Accordingly, it cannot be determined whether a message has been successfully delivered to a pager and read by the recipient.

Mobile telecommunications networks may not have the coverage of paging networks, but the Short Message Service (SMS) and Multimedia Message Services (MMS) systems of the networks are regularly used to contact mobile phone users. These message service systems send and receive short text messages of fixed length between mobile phone devices. They are distinct from email messaging systems and users are charged by network operators for messages sent from their devices. The message service systems, and the protocols they are based on, however, suffer similar deficiencies to the paging networks in that there is no reliable mechanism included in the systems for determining whether a message has been received and read by the recipient. This is particularly important in emergency situations. There is also no system provided for managing the messages sent and determining the current status of each message.

Accordingly, it is desired to address the above or at least provide a useful alternative.

### SUMMARY

In accordance with the present invention, there is provided a messaging system for a wireless communications network, including:
a creation component for creating a message;
a sending component for transmitting the message as a message service message for a recipient, and for adding to said message instructions for the recipient for providing an acknowledgement;
an acknowledgement component for processing response data to determine whether said response data represents said acknowledgement for said message;
a database for maintaining status data for said message, said status data being set by one or more of the components; and
an interface component for use in displaying a status of said message based on said status data.

The present invention also provides a user interface of a messaging system for a wireless communications network, including:
a creation part for creating messages and causing the messages to be sent a message service message to recipients, said messages being sent with instructions for providing an acknowledgement;
a message status part for obtaining status data for said messages, and displaying a respective status of each of said messages based on said status data, said status including at least one of acknowledgement and receipt.

The present invention also provides a messaging process performed by a computer implemented messaging system for a wireless communications network, including:
storing a created message;
transmitting the message as a message service message for a recipient, said message being transmitted with instructions for providing an acknowledgement;
processing response data to determine whether said response data represents said acknowledgement for said message;
maintaining status data for said message representing one of a number of states of said message; and
displaying a status of said message based on said status data.

### DRAWINGS

Preferred embodiments of the present invention are hereinafter described, by way of example only, with reference to the accompanying drawings, wherein:

FIG. 1 is a block diagram of a first preferred embodiment of a messaging system for a wireless network according to the present invention;

FIG. 2 is a second preferred embodiment of a messaging system according to the present invention;

FIG. 3 is a state diagram representing a messaging process performed by the system;

FIG. 4 is a flow diagram of a message creation process performed by an application server component of the system;

FIG. 5 is a flow diagram of a sending process performed by a sending daemon of the system;

FIG. 6 is a flow diagram of a receipt checking process performed by a receipt checking daemon of the system;

FIG. 7 is a flow diagram of a reminder creation process performed by a reminder daemon of the system;

FIG. 8 is a flow diagram of an Internet acknowledgement process performed by an application server component of the system;

FIG. 9 is a flow diagram of a voice acknowledgement process performed by a phone call daemon of the system;

FIG. 10 is a flow diagram of an SMS acknowledgement process performed by an in-bound SMS daemon of the system;

FIG. 11 is a flow diagram of a cancellation process performed by an application server component of the system;

FIGS. 12, 13, 14, 16, 17, 18, 20, 21, 22 and 23 are screen displays provided by a Web and application server of the system; and

FIGS. 15 and 19 are displays on a mobile phone of messages sent by the system.

### DETAILED DESCRIPTION

A messaging system, described with reference to the accompanying drawings, generates and tracks messages, in particular Short Message Service (SMS) messages, for transmission over a wireless communications network, and generates tracking or status data relating to the status of these messages. The system enables management of the messages and compels acknowledgement of read messages. The messages are message service (e.g. SMS, EMS or MMS) messages that are transmitted using at least one mobile telephone network as short text messages of fixed length. An operator of the network will charge a cost for sending the messages.

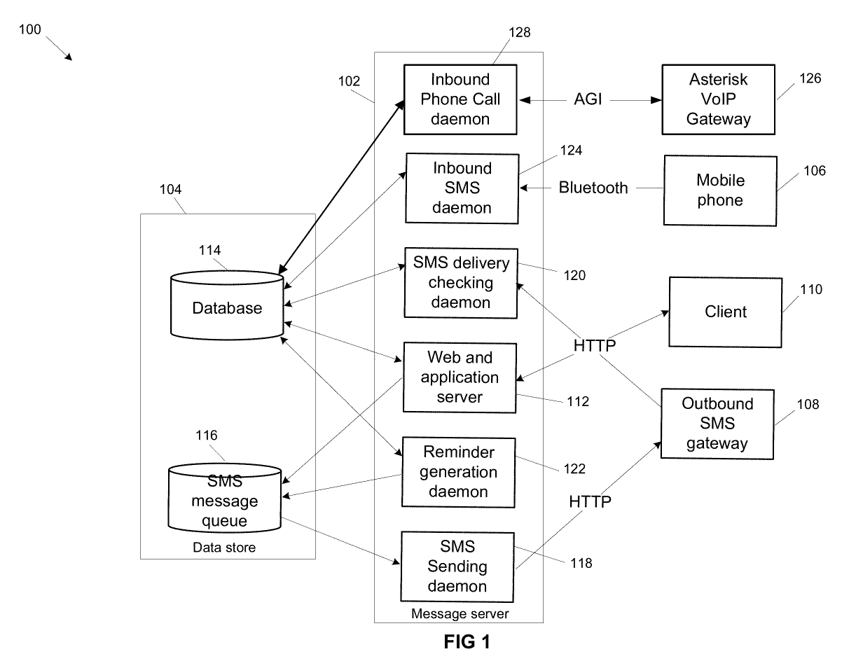

The messaging system can be provided by a gateway messaging system 100, as shown in FIG. 1, which includes a message server 102, a data store 104, a mobile phone 106 and an Interactive Voice Response (IVR) system 126. Messages are generated and monitored by the message server 102. Messages are generated based on data generated in a client device 110, such as a personal computer or PDA (personal digital assistant), which accesses the message server 102 via the Internet using communications based on the hypertext transfer protocol (HTTP). The client 110 allows a user of the gateway messaging system 100 to create/compose one or more SMS messages to be sent by the message server 102. The client 110 communicates with a Web and application server 112 of the message server 102 to access Web pages and create a message. The client 110 includes computer readable media (e.g. RAM, ROM, hard disk) for storing user interface parts, or components, served by the message server 102. The message server 102 communicates with an outbound SMS gateway 108, such as provided by SMS Global Ltd, by HTTP to send the message as an SMS message.

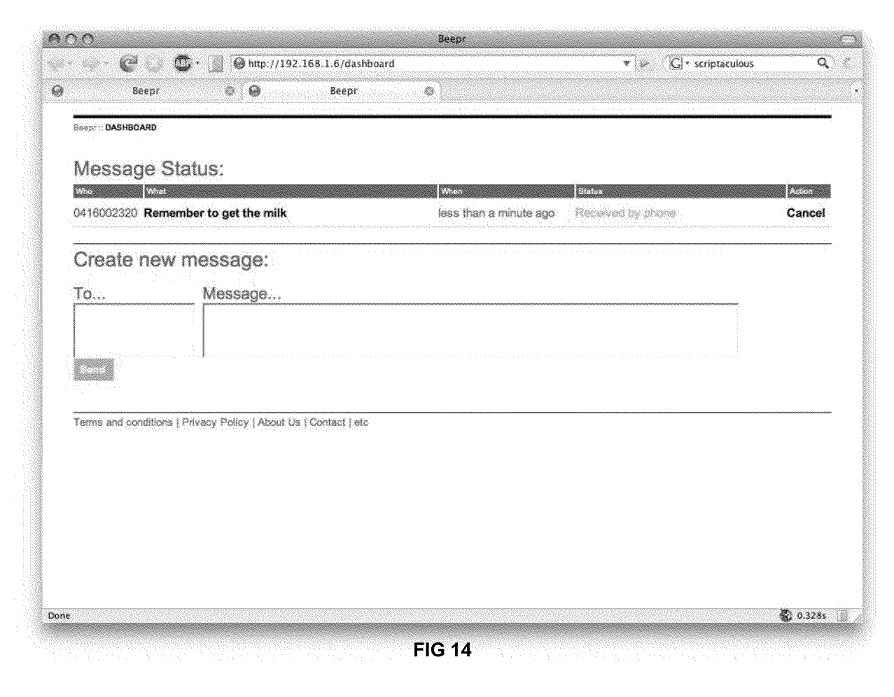

The Web and application server 112 in communication with the client 110 provides a creation component of the gateway messaging system 100 for creating the message The client 110, in communication with the Web and application server 112, accesses the creation component to generate a user interface for the user to create the message, e.g. as shown in FIG. 14. The user interface is rendered in a Web browser of the client 110 and allows the user to enter message data, including: a communications address or identifying code (e.g. mobile telephone number) for a recipient of the message; and text of the message.

Once created, the message represented by the message data is stored in a message record in a message database 114 of the data store 104. The message record includes the message text, the recipient communications address, e.g. phone number, a state representing the current state of the message in the messaging process 300, a unique acknowledgement URL for the message, and a delivery count representing the number of times this message has been sent to the recipient. The Web and application server 112 also adds to the message data, stored with the record, text data providing acknowledgement instructions.

The message is sent by the Web and application server 112 to an SMS message queue 116 in the data store 104 where messages are queued according to their respective sending schedules for sending by an SMS sending daemon 118 of the message server 102. The message status is updated in the database 114 to reflect that it has been placed in the queue for sending. The SMS sending daemon 118 retrieves the message from the SMS message queue 116 and transmits the message using HTTP over a network (e.g. the Internet) to the outbound SMS gateway 108 with the communications address, i.e. mobile telephone number of the recipient.

After the outbound SMS gateway 108 has sent the message to the wireless communications network, the gateway 108 receives receipt data from the mobile or cellular phone to which the message is sent once the phone has received the message. The receipt data is returned in accordance with the SMS protocol. An SMS delivery checking daemon 120 in the message server 102 accesses the gateway 108, via HTTP, to obtain the receipt data for sent messages. The receipt data indicates the message was successfully transmitted to the wireless network and received by a target wireless personal mobile communications device (e.g. a mobile telephone handset, or wireless PDA) of the message recipient on the wireless network. The recipient, or target, of the message is defined by the client 110 when creating the message based on the submitted mobile telephone number. The SMS delivery checking daemon 120 communicates with the database 114 to update the message record with the current message status, i.e. that the message has been received.

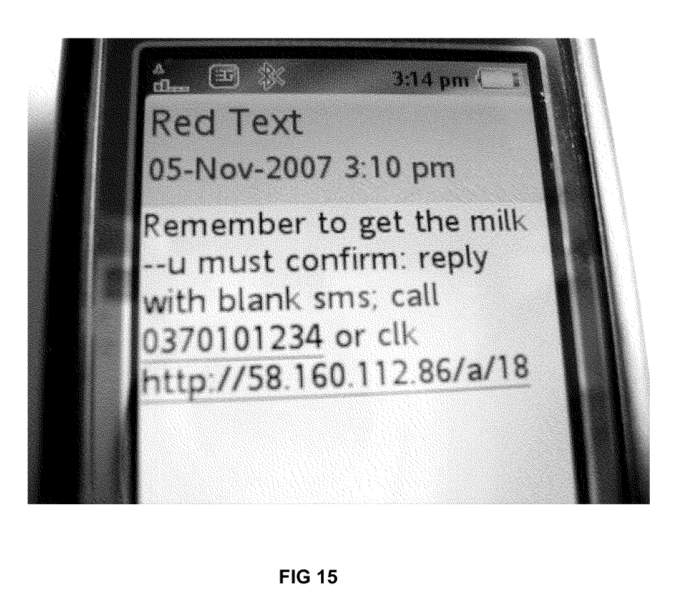

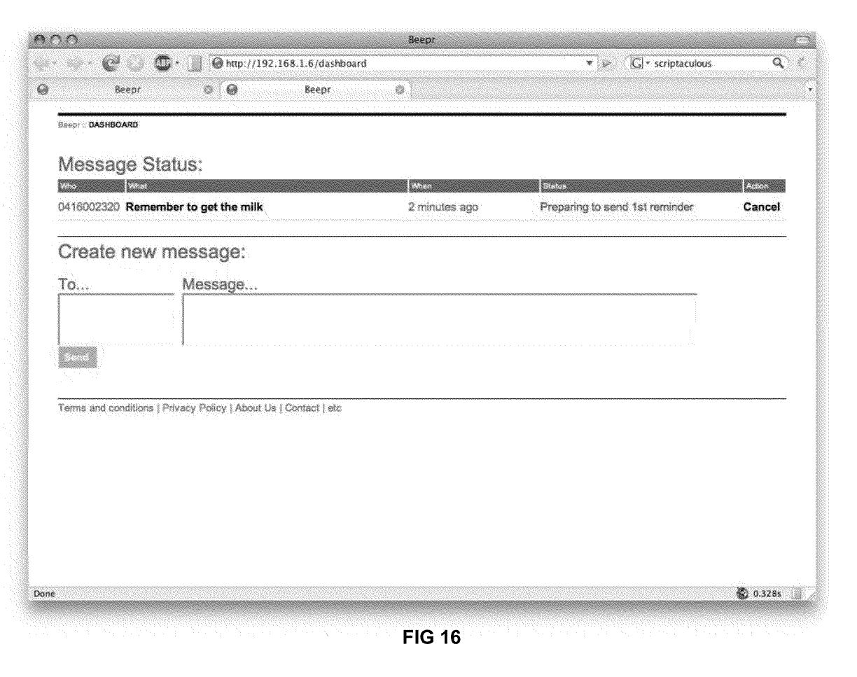

When the wireless communications device receives the message, the message can be read so the text of the message and the acknowledgement instructions are displayed by the destination phone for the recipient, e.g. as shown in the telephone screen image of FIG. 15.

The message recipient acknowledges receipt of the message in accordance with the acknowledgement instructions that are transmitted in the message. The gateway messaging system 100 includes an acknowledgement component for processing response data from the recipient to determine whether the response data represents an acknowledgement of the message. The acknowledgement component includes at least one of:
(i) a mobile phone 106 for receiving the response data (e.g. via a SMS reply message from the phone of the recipient) and an inbound SMS daemon 124 of the message server 102 that communicates with the phone 106 via a Bluetooth wireless connection;
(ii) an Interactive Voice Response (IVR) system in the form of an Asterisk VoIP gateway 126 for obtaining the response data, receiving voice acknowledgement data in response to a call from the recipient and an inbound phone call daemon 128 of the message server 102 that communicates with the IVR 126 via an asterisk gateway interface (AGI); and
(iii) the Web and application server 112 for receiving the response data as Internet acknowledgement data via HTTP from the phone of the recipient once the recipient selects a URL in accordance with the acknowledgement instructions (e.g. a URL received with the message) that sends a HTTP request to the server 112.

The acknowledgement component can be implemented differently to cater for different mechanisms and protocols for returning the response data from a recipient. For example, the recipient may receive the original message on a wireless device that can return the response data using various communication channels or processes, such as SMS, Voice, Instant Messaging (IM), email or HTTP.

The inbound SMS daemon 124, the inbound phone call daemon 128 and the Web and application server 112 receive response data representing the acknowledgement of receipt of the message, or equivalently of a subsequent reminder, and update the message record in the database 114.

The gateway messaging system 100 automatically generates one or more reminder messages for each message, based on the sending schedule of the message, under the control of a reminder generation daemon 122 of the message server 102. The reminder generation daemon 122 accesses the message's sending schedule in the database 114 or invokes a sending schedule that applies to all messages that have not been acknowledged and transmits the reminder message to the SMS message queue 116 for sending by the SMS sending daemon 118. One or more reminders may be scheduled for each message in the sending schedule. Reminders are sent when the message is not acknowledged as read by the recipient.

The Web and application server 112 transmits update data to the client 110 representing the current status of the message, including transmission of one or more reminder messages and receipt of one or more acknowledgements. The Web and application server 112 also sends update data to the client 110 representing the sending schedule and the times when the message, one or more reminder messages and any acknowledgements have been sent and received. The update data is accessed and used by the browser interface, e.g. dashboard, on the client 110 to update the display generated by the interface.

The message server 102 can be provided by a computer server, such as produced by IBM Corporation, which includes computer program instruction code written in Ruby to provide the daemons 118, 120, 122, 124 and 128 with the Web and application server 112 being provided using Ruby on Rails (http://www.rubyonrails.org) and Apache. The data store 104 may be implemented using MySQL (http://www.mysql.com) and provided on the same machine as the server 102 or a separate database server. Other alternatives are available where, for example, the components 112 to 128 are provided on one or more separate machines and any computer program code required can implemented based on the .Net framework (http://msdn.microsoft.com/netframework). Any computer program code is stored on computer readable storage media, such as computer memory of the server 102 and/or the data store 104. Also, the computer program instruction code can be replaced, at least in part, by hardware circuits (e.g. ASICs and FPGAs), particularly to improve processing speeds for those parts of the process that do not need to be regularly reconfigured.

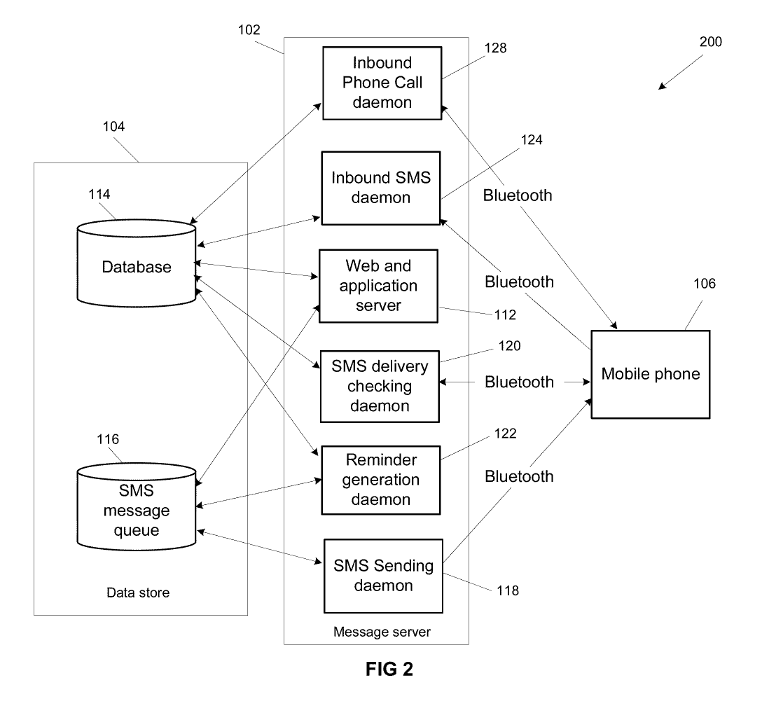

In an alternative form of the messaging system, the outbound SMS gateway 108 may be replaced with the SMS send functions of the mobile phone 106, as shown in the stand-alone messaging system 200 of FIG. 2. As in the gateway messaging system 100, the mobile phone 106 in the stand-alone messaging system 200 communicates with the message server 102 via the Bluetooth wireless connection, and the message server 102 uses AT commands to control the phone 106 and obtain data from it. The AT commands are from 3GPP TS 27.005 Use of Data Terminal Equipment—Data Circuit terminating Equipment (DTE-DCE) interface for Short Message Service (SMS) and Cell Broadcast Service (CBS) available from: http://www.3gpp.org/ftp/Specs/html-info/27005.htm. For example the following commands can be used:

| AT Command | Description |
|---|---|
| AT+CMGF=1 | Switch phone to SMS text mode |
| AT+CMGL=“ALL” | List all SMS messages in phone memory |
| AT+CMGD=<id> | Delete SMS message with id of <id> |

The following is a Log File showing use of the commands:

### >>ATE0

### <<OK

### >>AT+CMGF=1

### <<OK

### >>AT+CMGL=“ALL”

### <<+CMGL: 0,“REC READ”,“+61414591100”,“06/01/09,23:13:12+44”

<<The text of an SMS message.

### <<OK

### >>AT+CMGD=0

### <<OK

In the stand-alone messaging system 200, The message is sent from the SMS sending daemon 118 over the Bluetooth connection using the SMS sending capabilities of the mobile phone 106. The mobile phone 106 replaces the asterisk VoIP gateway 126 of the gateway messaging system 100. Instead, voice calls are received by the mobile phone 106 and caller identification (ID) information for the incoming voice calls is transmitted between the inbound phone call daemon 128 and the mobile phone using the Bluetooth wireless connection. Similarly, acknowledgement data for the inbound SMS daemon 124 is transmitted to the mobile phone 106 and over the Bluetooth connection. The data store 104 of the stand-alone messaging system 200, including the database 114 and the SMS message queue 116, is functionally equivalent to the data store 104 of the gateway messaging system 100, and both the message server 102 and the data store 104 would be on one machine, e.g. a personal computer, such as produced by Apple Inc. or Lenovo Group Limited, with a Bluetooth network communications card. In this implementation all of the components 112, 114, 116, 118, 122, 124 and 128 may be implemented using computer program code stored on computer readable media, e.g. the hard disk of the personal computer providing the message server 102 and the data store 104.

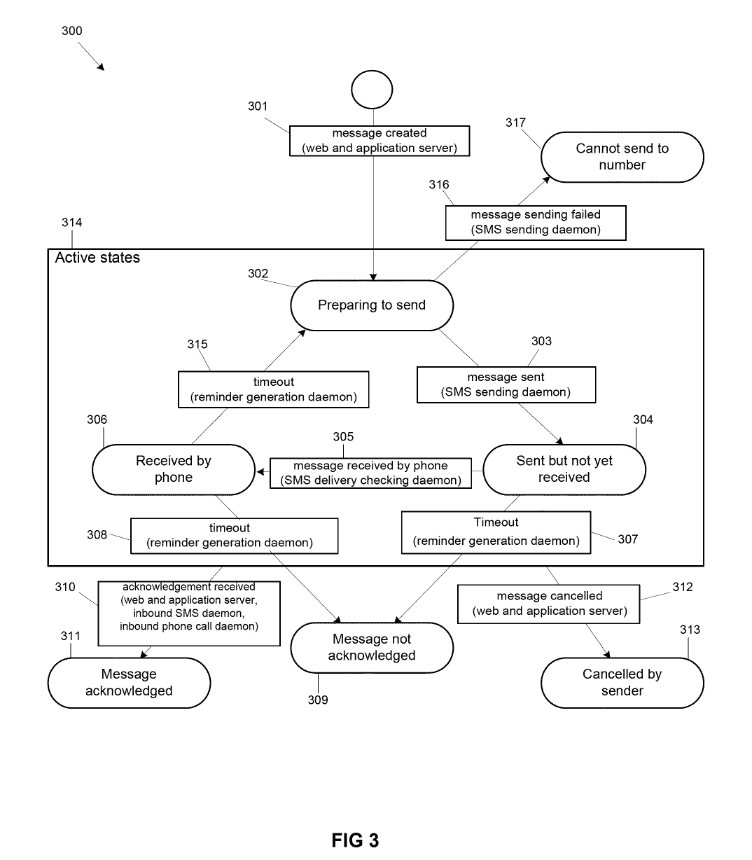

The messaging system 100 performs a messaging process 300, represented by the state diagram in FIG. 3, for each original message.

The Web and application server 112 creates a new message, in response to a request from the client 110, at step 301, and sets its state to a “preparing to send” state 302. The SMS sending daemon 118 finds messages in the “preparing to send” state 302, and attempts to send them via the Outbound SMS gateway 108. If sending fails, the message state is set to a “cannot send to number” state 317 at step 316, and processing of the message terminates. If sending succeeds, the message state is set to a “sent but not yet received” state 304 at step 303.

The SMS delivery checking daemon 120 periodically checks, using the Outbound SMS gateway 108, if messages in the “sent but not yet received” state 304 have been received by the recipient's phone. If a message is found to have been received, its state is changed at step 305 to a “received by phone” state 306.

If the message is not received within a pre-determined time interval after it is sent (step 303), the Reminder generation daemon 122 sets the message state at step 307 to a “message not acknowledged” state 309, and processing of the message terminates.

At any time while a message is in one of the Active states 314 (i.e. the “preparing to send” state 302, the “sent but not yet received” state 304, or the “received by phone” state 306), the recipient may acknowledge the message (step 310) via the Web and application server 112, the Inbound SMS daemon 124, or the Inbound phone call daemon 128. When this happens, the message state is set at step 310 to a “message acknowledged” state 311 and processing of the message terminates.

If the recipient does not acknowledge the message within a pre-determined time interval after it is sent (step 303), and the message has been sent less than a pre-determined number of times, the Reminder generation daemon 122 returns the message to the “preparing to send” state 302 at step 315, thereby causing it to be re-sent. If the message has been sent more than a pre-determined number of times with no acknowledgement, the Reminder generation daemon 122 sets the message state at step 308 to the “message not acknowledged” state 309 and processing of the message terminates. The pre-determined time interval and number of re-send times are set by configuration options by the client 110, or by an owner/operator of the messaging system.

At any time during the processing of a message, the sender can cancel the message by issuing a request to the Web and application server 112, which then sets the message state at step 312 to a “cancelled by sender” state 313, and terminates processing of the message.

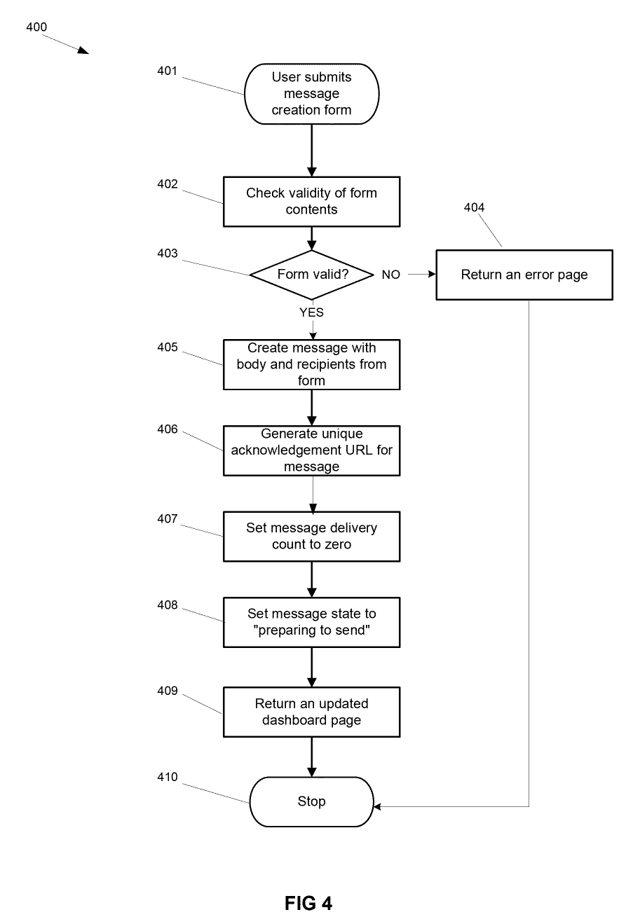

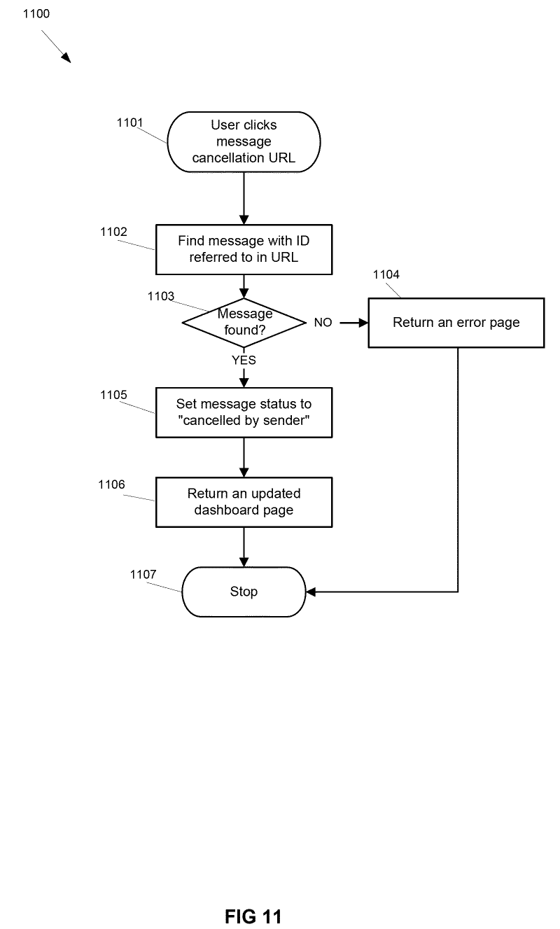

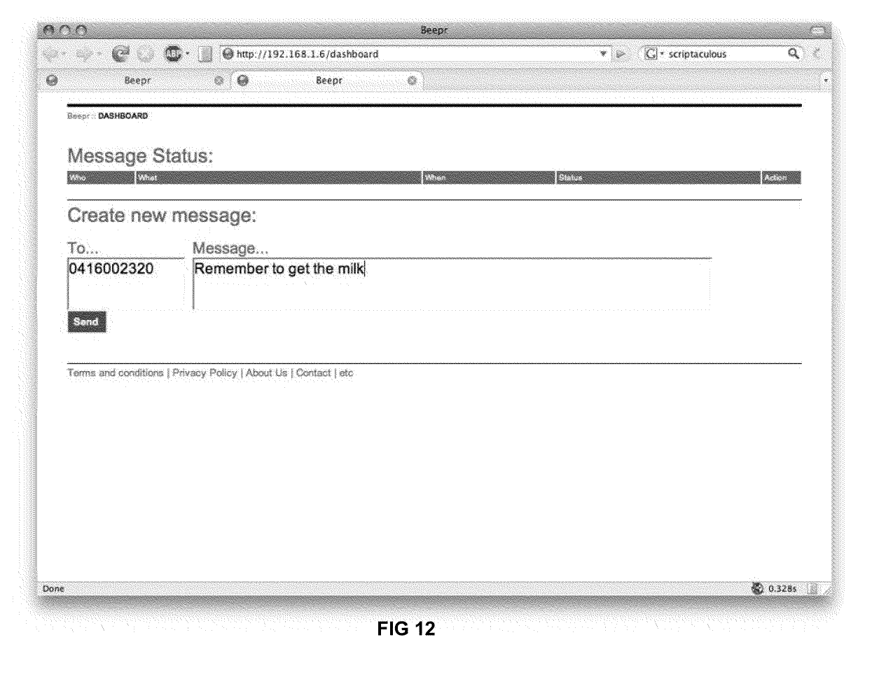

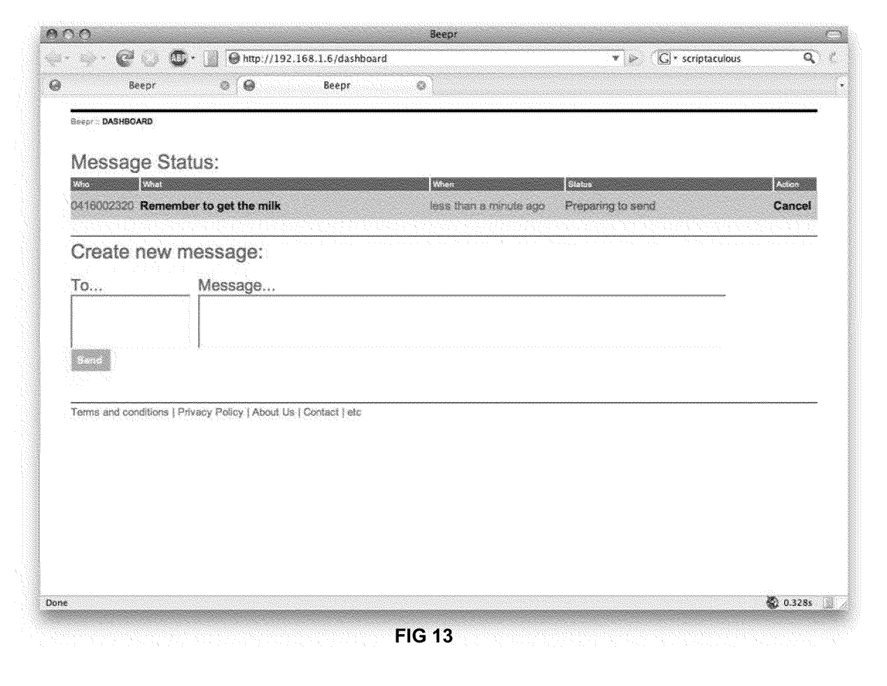

The details of the processes performed by the various daemons and the Web and application server 112 are illustrated in FIGS. 4 through 11, and described below.

The Web and application server 112 creates a message using the message creation process 400 shown in FIG. 4. The user, using the client 110, fills in an online form provided by the Web and application server 112 requiring information in relation to the message, as shown in the user interface of FIG. 14. The user submits the required message data representing the message, and clicks “send” to send the message data from the client 110 to the Web and application server 112 (step 401). The message data includes the MSISDN (telephone number) of a mobile or cell phone associated with or of the recipient and the text data of the message, e.g. “Remember to get the milk”. The validity of the contents (e.g. that the recipient's phone number is in the correct format) is determined by the Web and application server 112 at step 403. If the form is invalid, the Web and application server 112 generates an error message for the client 110 to tell the user to correct any errors in their selected message data (step 404). If the form is valid (step 403), a message record in the database 114 is created containing the message data (step 405).

Once the message record is created for the message, a unique acknowledgement URL is generated for the message (step 406). Its initial delivery count is set to zero (step 407), and its status is set to the “preparing to send” state 302 (step 408). The Web and application server 112 generates data updating the user interface of the client 110 (step 409) to display the new message status, e.g. as shown in FIG. 15 where the “message status” has been updated, indicating the details of the message (i.e. the recipient number “who”, the message text “what”, the time sent “less than a minute ago”, and the current state of the message “preparing to send”).

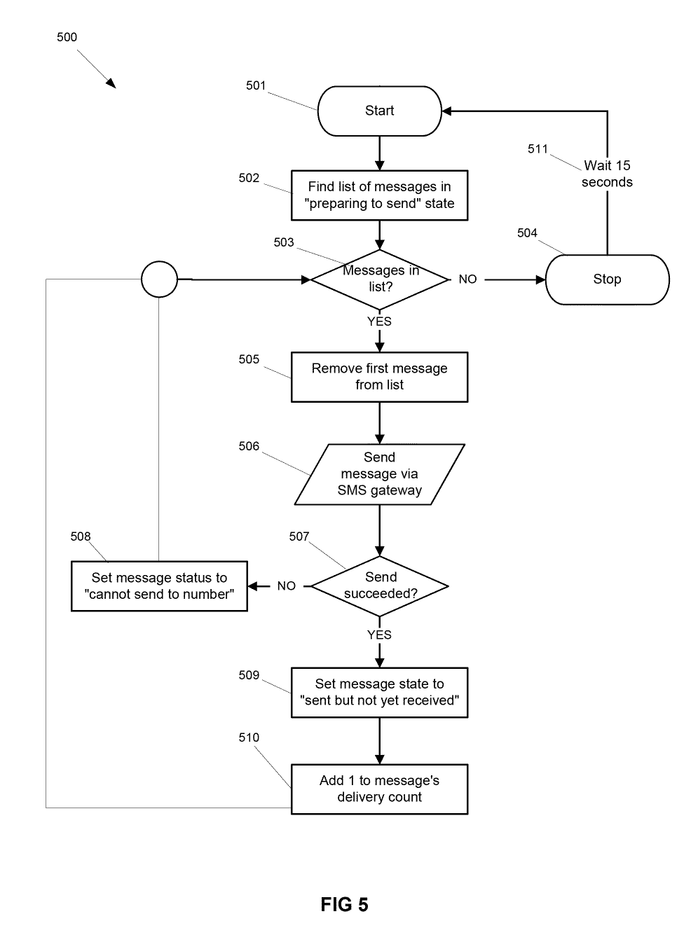

A sending process 500, shown in FIG. 5, is executed by the SMS sending daemon 118. It finds messages in the database 114 in the “preparing to send” state 302 (step 502). It goes through this list (step 503) removing each message (step 505), and attempting to send it (step 506) using the Outbound SMS gateway 108. If sending the message fails (e.g. because the recipient phone number is invalid, doesn't exist, is not able to receive SMS, or is not able to be routed to by the gateway provider), the message state is set at step 508 to the “cannot send to number” state 317, and the next message in the list is processed. If sending succeeds, the message status is set at step 509 to the “sent but not yet received” state 304, and the delivery count for the message is increased by one (step 510), before the next message is processed. When there are no more messages to be processed, the SMS sending daemon 118 waits 15 seconds (step 511) before checking for messages again.

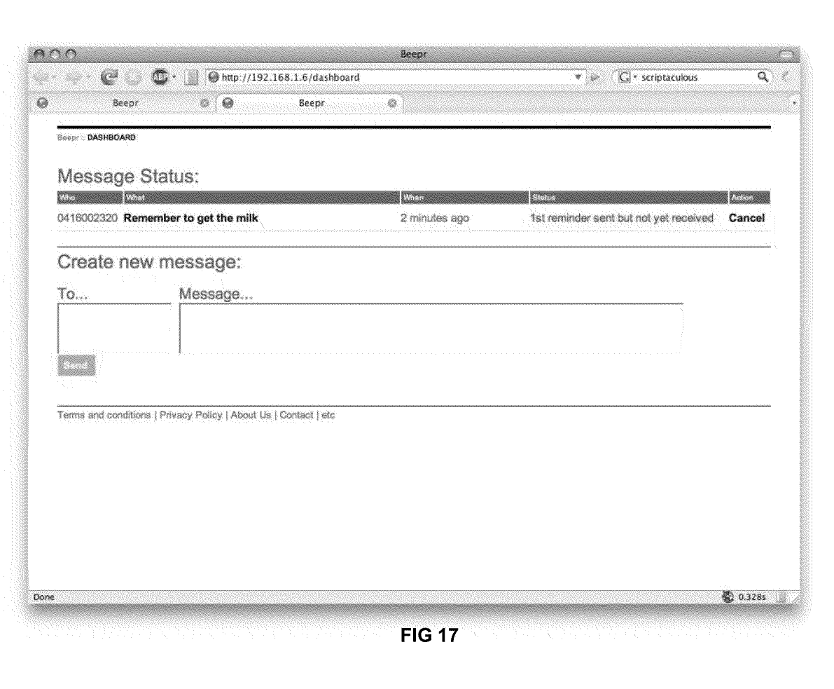

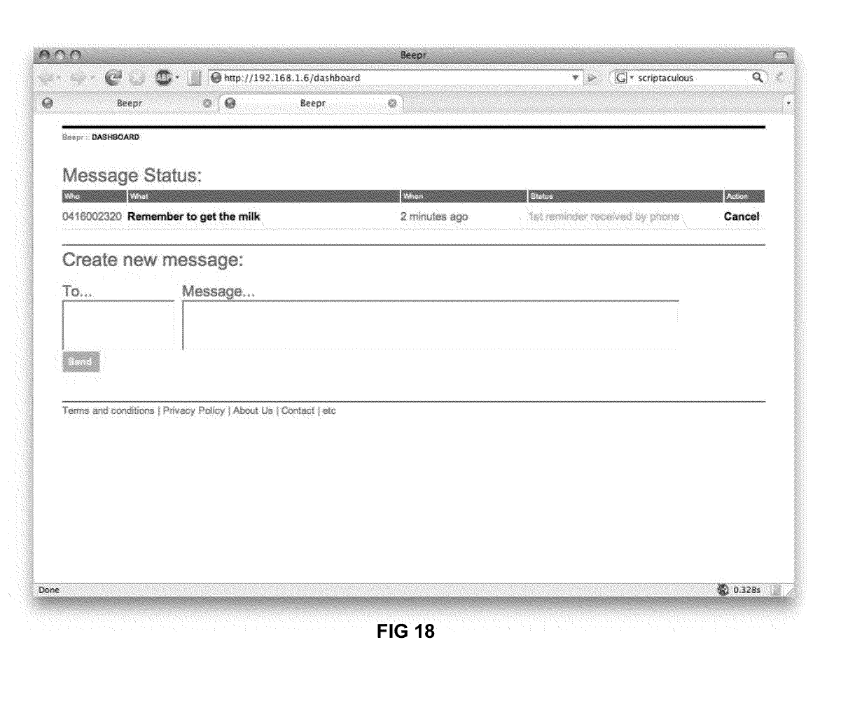

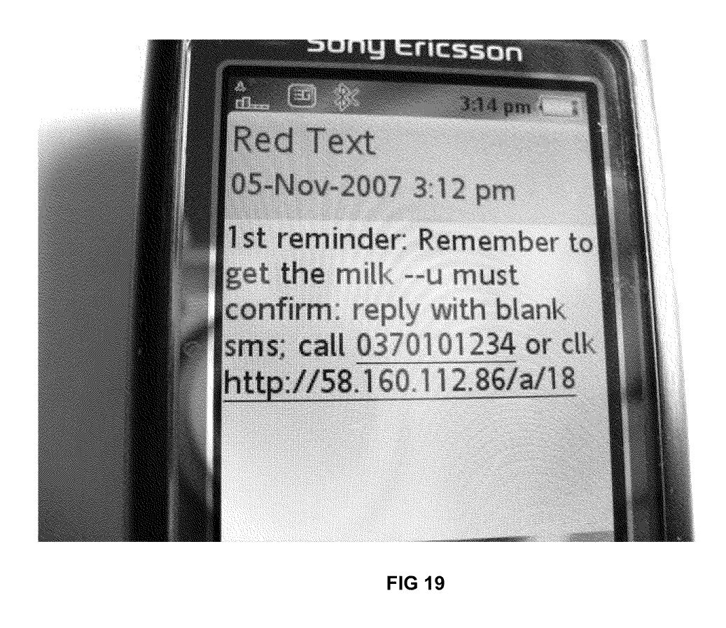

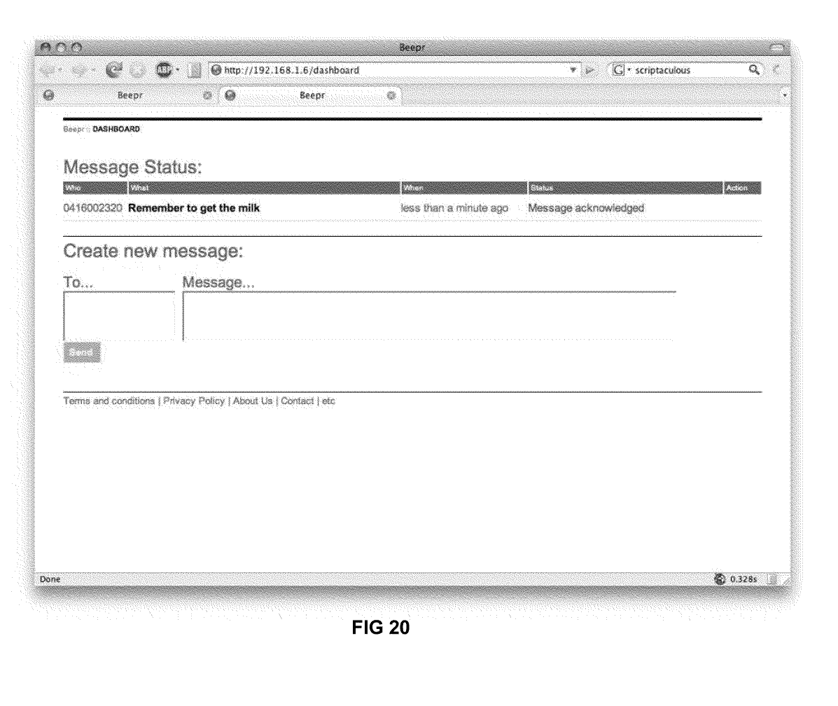

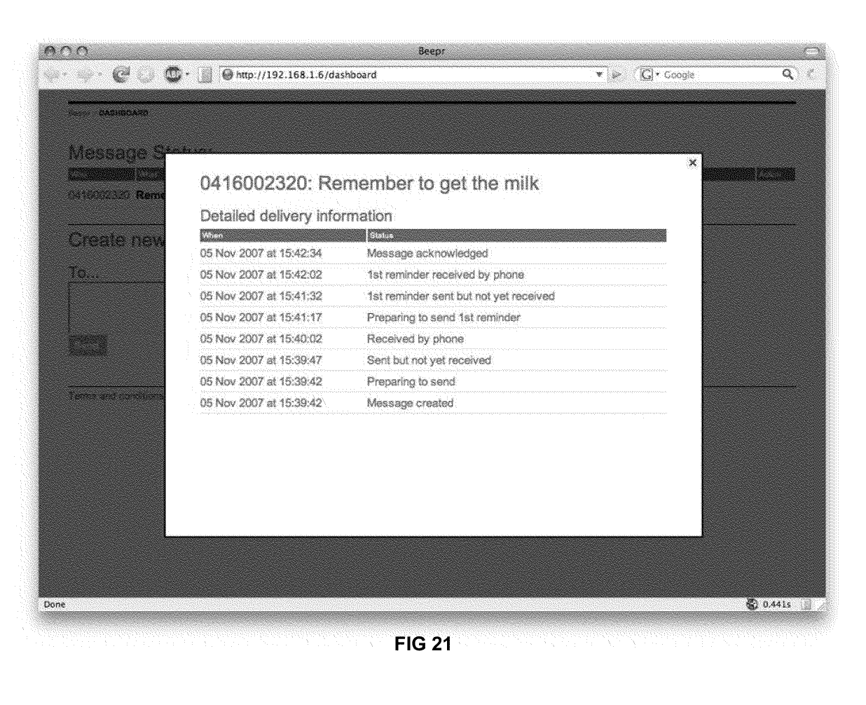

When the message is received by the wireless communications device of the recipient, the device can display the text of the message, together with the acknowledgement instructions providing information explaining what actions are to be taken to acknowledge the message, e.g. as shown in FIG. 17. The message text is for example “Remember to get the milk”. The acknowledgement information provides instructions for Internet, SMS and voice acknowledgement, e.g. “u must confirm: reply with blank sms; call 0370101234; or click http://58.160.112.86/a/18”, as shown in FIG. 17.

In the alternative form of the messaging system 200, shown in FIG. 2, the Sending process 500 sends outbound messages through the mobile phone 106 (rather than the Outbound SMS gateway 108).

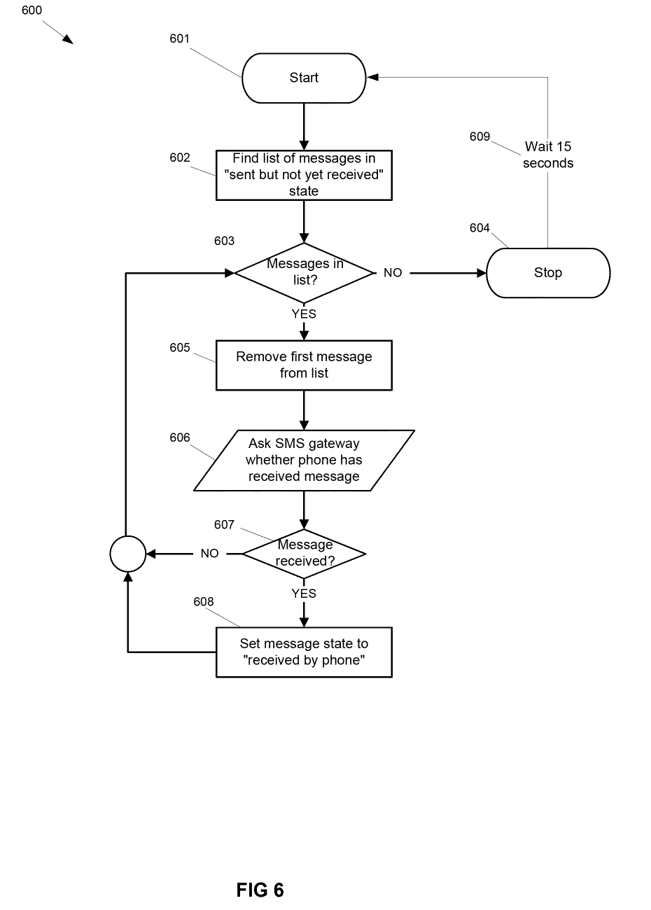

When the message is received, the wireless communication device (phone) automatically generates and sends to the Outbound SMS gateway 108 data indicating receipt of the message. A delivery checking process 600, shown in FIG. 6, is executed by the SMS delivery checking daemon 120. It finds messages in the database 114 in the “sent but not yet received” state 304 (step 602). It goes through this list (step 603) removing each message (step 605), and checking (step 606) with the Outbound SMS gateway (108) if the message has been received by the recipient's mobile phone. If it has been received, it sets the message status at step 608 to the “received by phone” state 306. When there are no more messages to be processed, the SMS delivery checking daemon 120 waits 15 seconds (step 609) before checking for messages again.

In the alternative form of the messaging system 200, shown in FIG. 2, the Delivery checking process 600 performed by the daemon 120 checks for acknowledgement receipts through the mobile phone 106 (rather than the Outbound SMS gateway 108) using AT commands.

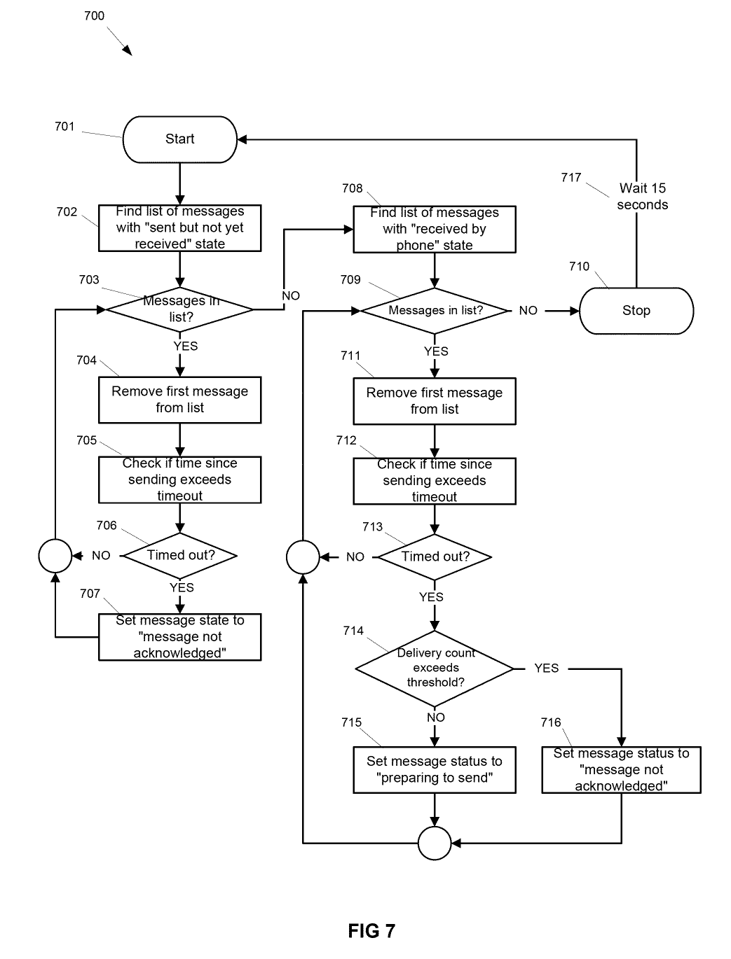

A reminder generation process 700, shown in FIG. 7, is executed by the Reminder generation daemon 122. The reminder generation daemon 122 finds messages in the database 114 in the “sent but not yet received” state 304 (step 702). It goes through this list (step 703) removing each message (step 704), and checking if a pre-determined time interval has elapsed since the message was sent (step 705). If the time interval has been exceeded, it sets the message state at step 707 to the “message not acknowledged” sate 309.

If no messages in the “sent but not yet received” state 304 were found at step 702, or if all those message have been processed, the Reminder generation daemon 122 finds messages in the “received by phone” state 306 (step 708). It goes through this list (step 709) removing each message (step 711), and checking if a pre-determined time interval has elapsed since the message was sent (step 712). If the time interval has been exceeded (step 713), it checks if the message has been sent to the recipient more than a pre-determined number of times (step 714). If this delivery count has been exceeded, it sets the message status at step 716 to the “message not acknowledged” state 309, otherwise it sets the message status at step 715 to the “preparing to send” state 302.

When there are no more messages to be processed, the Reminder generation daemon 122 waits 15 seconds (step 717) before checking for messages again.

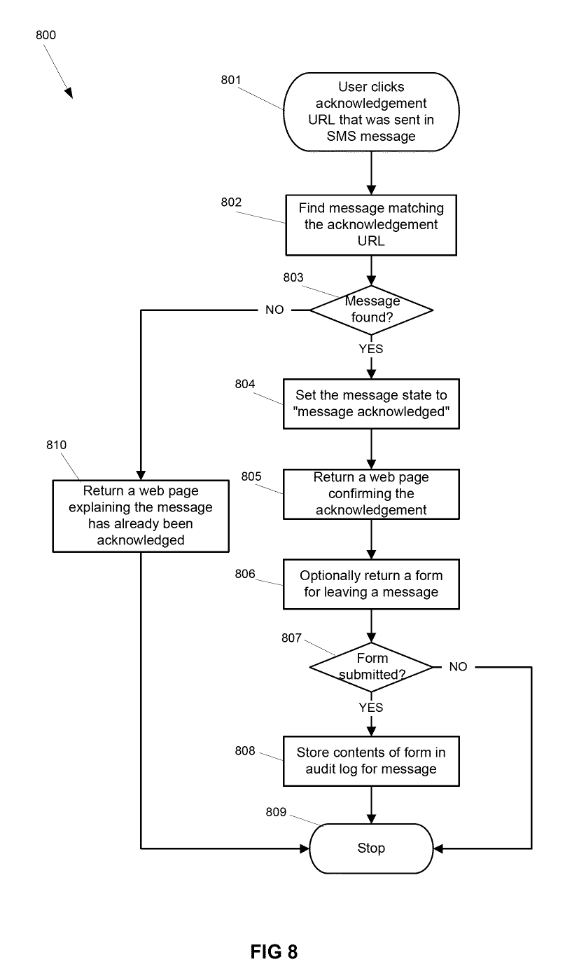

An Internet acknowledgement process 800, shown in FIG. 8, commences when the recipient of the message clicks on an Internet acknowledgement link sent with the message, e.g. as displayed in the screen capture of FIG. 17: “http://58.160.112.86/a/18” (step 801). Activation of the Internet acknowledgement link sends a HTTP request with the link data (i.e. the response data), and causes the Web and application server 112 to access the database 144 to determine whether a message record exists in any of the Active states 314, with an acknowledgement URL matching the Internet acknowledgement link (step 802). If a matching message is found (determined in step 803) the message record in the database 114 has its state set at step 804 to the “message acknowledged” state 311. If no corresponding/matching message is found in the database 114, the Web and application server 112 generates a Web page for the wireless communication device that has accessed the Internet acknowledgement link, the Web page containing information indicating that the message was not found, e.g. that the message had already been acknowledged in the past (step 810).

When the Internet acknowledgement link is accessed by the wireless communications device (in step 801), the Web application server 112 returns a Web page to the recipient's phone confirming the acknowledgement (step 805) and providing an optional Web-based form for submitting a message to the system 100 (step 806). The recipient can use the phone to optionally submit/send further data to the Web and application server 112 through the form. If this further data is submitted (determined in step 807) the content of the submitted data is stored in an audit log associated with the record of the message in the database 114 (step 808) For example, the further data could be a request to change the time of an appointment between the sender and recipient. If no further data is submitted by the wireless communications device, the Internet acknowledgement process 800 ends (step 809).

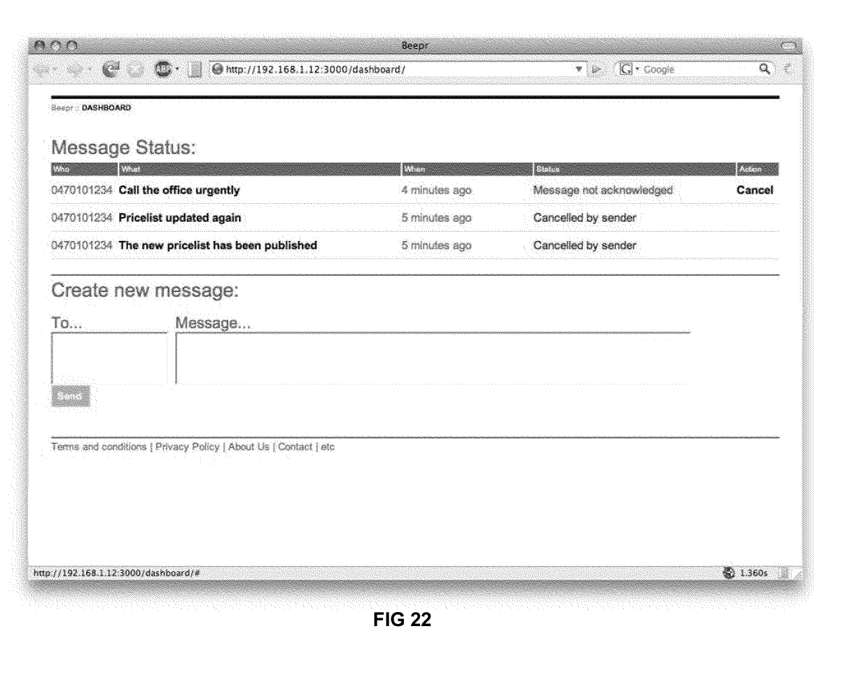

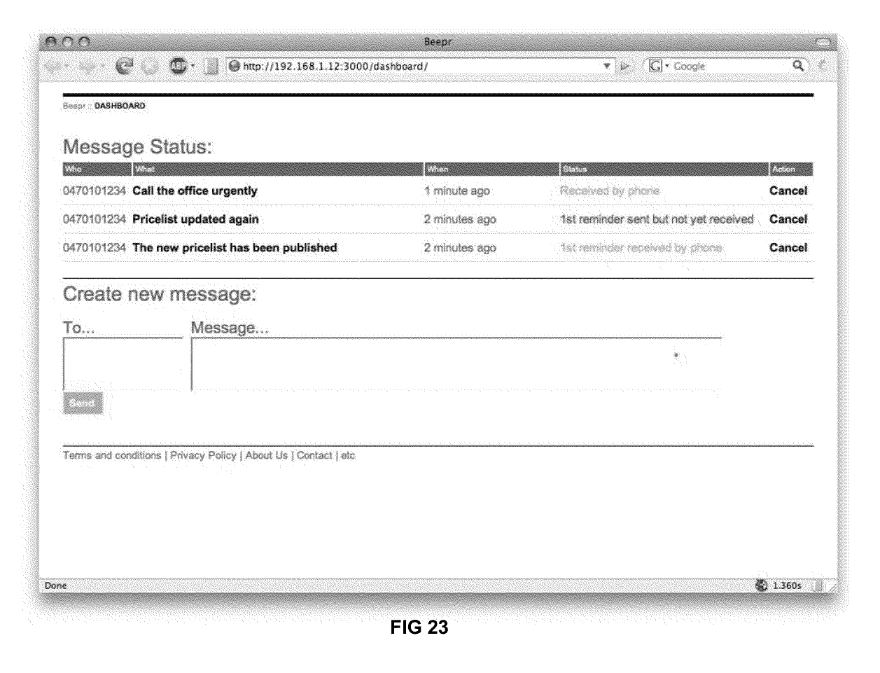

Following acknowledgement of the message, the Web and application server 112 generates data updating the user interface of the client 110 indicating that the message has been acknowledged, e.g. as shown in the screen shot of FIG. 22, based on the changed state in the message record.

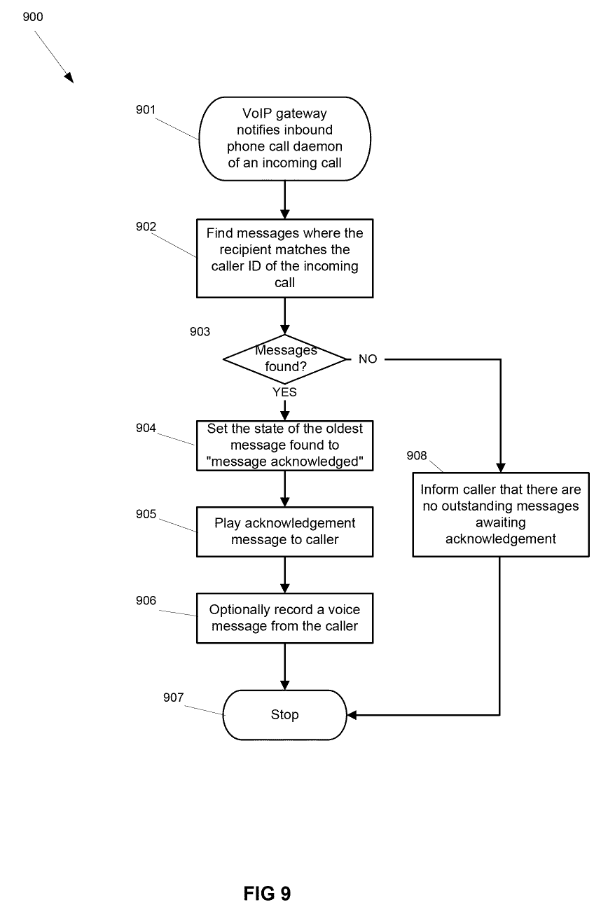

A Voice acknowledgement process 900, shown in FIG. 9, commences when the recipient of a message calls the telephone number generated in the acknowledgement instructions, via the wireless communications device, to connect to the VoIP gateway 126 or phone 106. The VoIP gateway 126, or phone 106, notifies the Inbound phone call daemon 128 of the incoming call at step 901. The Inbound phone call daemon 128 searches the database 114 message records in any of the Active states 314 where the message code of the recipient (i.e. the mobile telephone number) matches the caller identification number (the “caller ID”) of the communications device that accessed the gateway 126 or phone 106 respectively (step 902). If no messages are found (determined at step 903) the inbound phone call daemon 128 plays an audio message to the caller at step 908 indicating that there are no outstanding messages awaiting acknowledgment, and terminates the Voice acknowledgement process 900. If a message is found that matches the caller ID of a received voice acknowledgement, the message record's state is set at step 904 to “message acknowledged” 311, and an audio acknowledgement message is played to the caller at step 905. The Web and application server 112 updates the user interface accordingly, e.g. as shown in FIG. 22.

Optionally, the recipient can leave a voice message which is recorded at step 906 and saved in the database 114 in an audit log associated with message. For example, the voice message could indicate that the recipient will be late for an appointment with the sender.

In the alternative form of the messaging system 200, shown in FIG. 2, the Voice acknowledgement process receives inbound phone calls from the mobile phone 106 (rather than the VoIP gateway 126). This may involve the Inbound phone call daemon 128 polling the mobile phone 106 at regular intervals for received phone calls.

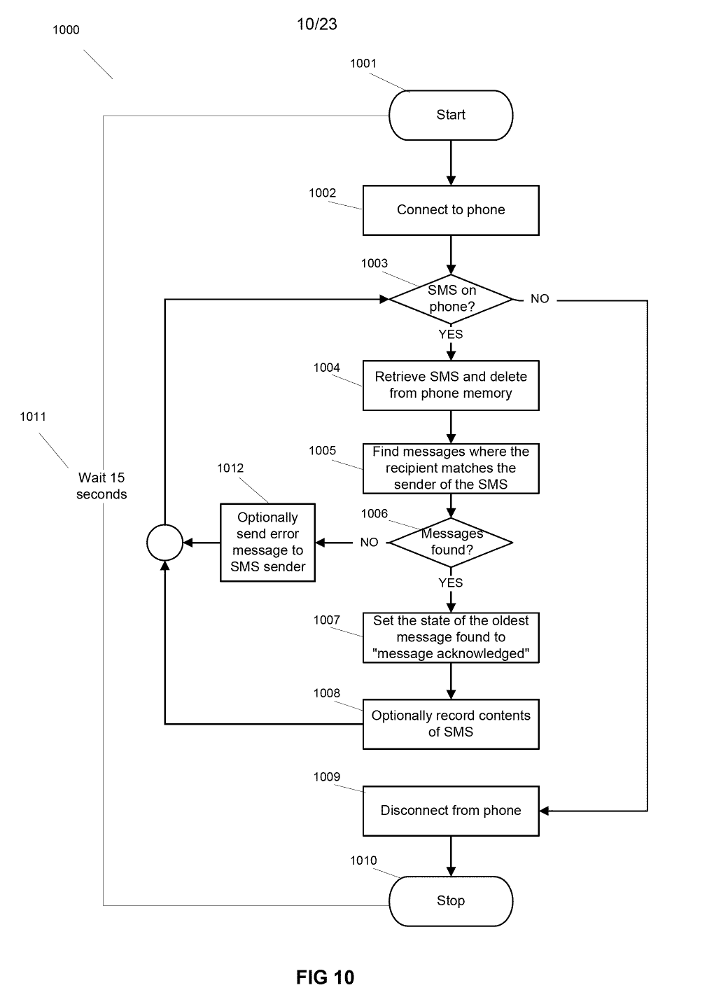

A recipient may also acknowledge a message by sending an SMS message from their wireless communication device to the mobile phone 106. In an SMS acknowledgement process 1000, shown in FIG. 10, the Inbound SMS daemon 124 connects to the mobile phone 106 over the Bluetooth wireless connection (step 1002) using AT commands to determine whether an inbound SMS message is stored, or has been received by, the mobile phone 106 (determined at step 1003). If an inbound SMS is on the phone 106, the inbound SMS daemon 124 retrieves the SMS message and deletes its data from the memory of the phone 106 (step 1004). After receiving the messages from the mobile phone 106, the Inbound SMS Daemon 124 searches the database 114 for message records in any of the Active states 314, where the SMS number of the recipient matches the sender of the SMS message returned from the phone (step 1005). If no matching message is found (determined at step 1006), the SMS acknowledgement process 1000 optionally sends an SMS message to the sender of the SMS message returned from the phone at step 1012 informing them that there are no outstanding messages awaiting acknowledgement. The SMS acknowledgement process 1000 then proceeds to recheck whether there is a message on the phone (i.e. repeat step 1003). If a matching message to the retrieved message (response data) is found in the database 114, the state of the message record is set at step 1007 to the “Message acknowledged” state 311. Optionally the content of the received SMS is stored in the database 114 in an audit log associated with the message (step 1008). The SMS acknowledgement process 1000 then returns to step 1003 to check for additional messages on the mobile phone 106.

If no message is found on the phone at step 1003, the Inbound SMS daemon 124 disconnects from the phone (step 1009), the SMS acknowledgement process 1000 ceases (step 1010), and the Inbound SMS daemon 124 waits for a preselected period of time (step 1011) before repeating the acknowledgement process 1000, e.g. 15 seconds.

A sender may initiate the Cancellation process 1100 by selecting a cancel HTTP link for the message (step 1101) using the client 110. The Web and application server 112 finds the message in the database 114 identified by the cancellation URL (step 1102). If no message is found (determined at step 1103), an error page is returned to the client 110 (step 1104). If a matching message is found, its state is set at step 1105 to the “cancelled by sender” state 313. An updated UI dashboard page reflecting the cancelled message is returned to the client 110 at step 1106, and the Cancellation process 1100 ceases at step 1107.

In an alternate implementation, multiple inbound phone numbers are allocated to the Asterisk VoIP gateway 126. When outbound messages are generated by the Sending process 500, an inbound phone number is dynamically allocated to the message such that each of the recipient's messages in any of the Active states 314 is assigned a different number. The allocated number for a message is sent out in the acknowledgement instructions for that message. When the recipient acknowledges the message using the Voice acknowledgement process 900, the Inbound phone call daemon 128 identifies the particular message being acknowledged by finding a message for that recipient in any of the Active states 314 and matching the phone number on which the acknowledgement call was received.

Similarly, multiple mobile phones can be used in place of the mobile phone 106. When outbound message are generated by the Sending process 500, an inbound SMS number is dynamically allocated to the message such that each of the recipient's messages in any of the Active states 314 is assigned a different number. The allocated number for a message is sent out in the acknowledgement instructions for that message. When the recipient acknowledges the message using the SMS acknowledgement process 1000, the Inbound SMS daemon 124 identifies the particular message being acknowledged by finding a message for the recipient in any of the Active states 314 and matching the inbound SMS number on which the acknowledgement SMS was received.

Many modifications will be apparent to those skilled in the art without departing from the scope of the present invention as herein described with reference to the accompanying drawings.

1. A messaging system for a wireless communications network, including:
a creation component for creating a message;
a sending component for transmitting the message as a message service message for a recipient, and for adding to said message instructions for the recipient for providing an acknowledgement;
an acknowledgement component for processing response data to determine whether said response data represents said acknowledgement for said message;
a database for maintaining status data for said message, said status data being set by one or more of the components; and
an interface component for use in displaying a status of said message based on said status data.

2. A messaging system as claimed in claim 1, including a reminder generation component for generating and transmitting a reminder message for said recipient when said acknowledgement is not received after a period of time.

3. A messaging system as claimed in claim 2, wherein the reminder component generates a number of reminder messages.

4. A messaging system as claimed in claim 3, wherein the reminder messages include said message.

5. A messaging system as claimed in claim 1, wherein the response data is included in a message service message received in reply to said message.

6. A messaging system as claimed in claim 1, wherein the response data is included in a HTTP request received in response to the recipient selecting a HTTP link of the instructions.

7. A messaging system as claimed in claim 1, wherein the response data is stored by an Interactive Voice Response system (IVR) in response to a call by the recipient.

8. A messaging system as claimed in claim 1, including a receipt component for accessing receipt data to determine whether said message has been received by a wireless communications device associated with said recipient.

9. A messaging system as claimed in claim 1, wherein said status data represents one of the following active states for said message:
(a) preparing to send the message;
(b) received by a wireless communications device associated with the recipient;
(c) the message has been sent but not yet received by the wireless communications device;
(d) the message is acknowledged;
(e) the message is not acknowledged;
(f) the message is cancelled by the system.

10. A messaging system as claimed in claim 9, wherein the status data for the message is set to represent message not acknowledged when the reminder component has sent a predetermined number of reminder messages, and said response data representing said acknowledgement has not been received by said acknowledgement component.

11. A messaging system as claimed in claim 1, wherein said message service message is one of a SMS, EMS and MMS message.

12. A user interface of a messaging system for a wireless communications network, including:
a creation part for creating messages and causing the messages to be sent a message service message to recipients, said messages being sent with instructions for providing an acknowledgement;
a message status part for obtaining status data for said messages, and displaying a respective status of each of said messages based on said status data, said status including at least one of acknowledgement and receipt.

13. A user interface as claimed in claim 12, including a detailed delivery information part for displaying a history of statuses for one of said messages.

14. A user interface as claimed in claim 12, wherein a Web and application server component of a message server of said system provides said parts, and said statuses are determined based on status data stored in a data store of the system and updated by:
(a) a sending component for transmitting the messages and adding instructions for the recipients for providing an acknowledgement; and
(b) an acknowledgement component for processing response data to determine whether the response data represents acknowledgements for the messages.

15. A messaging process performed by a computer implemented messaging system for a wireless communications network, including:
storing a created message;
transmitting the message as a message service message for a recipient, said message being transmitted with instructions for providing an acknowledgement;
processing response data to determine whether said response data represents said acknowledgement for said message;
maintaining status data for said message representing one of a number of states of said message; and
displaying a status of said message based on said status data.

16. A messaging process as claimed in claim 15, including generating and transmitting a reminder message for said recipient when after a period of time said status data represents the message has been received by a wireless communications device associated with the recipient and not acknowledged.

17. A messaging process as claimed in claim 16, including generating a number of said reminder messages periodically whilst said status data represents the message has been received by a wireless communications device associated with the recipient and not acknowledged.

18. A messaging process as claimed in claim 17, wherein the reminder messages include said message.

19. A messaging process as claimed in claim 15, wherein the response data is included in a message service message received in reply to said message.

20. A messaging process as claimed in claim 15, wherein the response data is included in a HTTP request received in response to the recipient selecting a HTTP link of the instructions.

21. A messaging process as claimed in claim 15, wherein the response data is stored by an Interactive Voice Response system (IVR) in response to a call by the recipient.

22. A messaging process as claimed in claim 15, including accessing receipt data from the network to determine whether said message has been received by a wireless communications device associated with said recipient.

23. A messaging process as claimed in claim 15, wherein said status data represents one of the following active states for said message:
(a) preparing to send the message;
(b) received by a wireless communications device associated with the recipient;
(c) the message has been sent but not yet received by the wireless communications device;
(d) the message is acknowledged;
(e) the message is not acknowledged; and
(f) the message is cancelled.

24. A messaging process as claimed in claim 23, wherein the status data for the message is set to represent message not acknowledged on sending a predetermined number of reminder messages and said response data representing said acknowledgement has not been received.

25. A messaging process as claimed in claim 15, wherein said message service message is one of a SMS, EMS and MMS message.

26. A personal computer configured to perform a messaging process as claimed in claim 15.
